(19) United States
(12) Patent Application Publication
(10) Pub. No.: US 2025/0139599 A1
(43) Pub. Date: May 1, 2025

(54) COIN RECYCLING SYSTEMS

(71) Applicants: VICTOR ABALO, NEW HOPE, MN (US); PROSPER DZAMESHIE, SAINT PAUL, MN (US); EGLOU GEORGE LOKOU, LAVON, TX (US)

(72) Inventors: VICTOR ABALO, NEW HOPE, MN (US); PROSPER DZAMESHIE, SAINT PAUL, MN (US); EGLOU GEORGE LOKOU, LAVON, TX (US)

(21) Appl. No.: 18/495,709

(22) Filed: Oct. 26, 2023

(51) Int. Cl. G06Q 20/10; G06Q 20/20

(52) U.S. Cl. CPC G06Q 20/10; G06Q 20/204

(57) ABSTRACT

A coin exchange or recycling system useful for crediting change from a cash transaction at a point of sale; such change being available for use at any merchant location or kept as a means of reducing the clutter from leaving excess coins unused. This disclosure brings value to recirculating coin change from cash transactions.

### BACKGROUND

When paying with cash for a product or service at a store or cash register, most consumers are often faced with having to get some change in coins back; or digging through their purses or wallets for some coins to complete the transaction. Invariably, there is need for coins to be used or collected in the process. Such steps leave the consumer or purchaser with coins that end up in a jar, car receptacles, pockets, office drawers, strewn around or lost. Some folks collect these coins in a receptacle of some sort and sparingly or regularly take it to the bank or similar institutions to exchange for bills; only to continue in the same routine all over again. This routine of collecting coins for exchange at some later time or lack of such routine still portends taking money from circulation even if temporarily and may be cumbersome for the consumer. In some circumstances, the coins are left, forgotten or discarded—still minimally or maximally taking money out of circulation.

One reason for such inefficiencies is that coins can be heavy or bulky when lugged around, and most people end up leaving the coins at the first open location or opportunity, whether convenient or not. There is some public discussion of taking some coins out of circulation, either because such coins hardly add up to a purchase or that the cost of producing them is more than the value of such coins, in any case—the penny coin being a typical example.

In an earlier iteration, the inventors developed a recycling system that utilized a registration process wherein such registration included a logging system that may be manual or incorporate recording by a merchant as informed in U.S. patent application Ser. No. 14/819,717 filed Aug. 20, 2020. This provides an improvement of that process for the user.

From the above, it is notable that what is needed in the marketplace is a process that provides a user-friendly process for utilizing the coins that are usefully part of a cash transaction for credits, latter use or simply taking such waste out of the transaction system. Such process and product to serve that need are included in this disclosure.

### SUMMARY

In one embodiment, the present invention provides a system wherein change from a cash transaction that would be provided in coins to a consumer may preferably be channeled to a recycling system for later use.

In yet another embodiment of the present invention, a method of converting loose coins to a machine or electronic readable deposit system usable for merchants or consumers.

A coin-loyalty system wherein a subscriber is provided a membership account to deposit coins and the facilities to withdraw from same or conduct a consumer transaction therefrom.

Another aspect of the present invention provides a system that is functional as a coin bank for users and consumers who opt to register with the application or facility.

### BRIEF DESCRIPTION OF THE DRAWINGS

This invention will be more readily understood from the following detailed description taken in conjunction with the accompanying drawings, in which:

FIG. 1 illustrates an embodiment of an activity path supporting a coin recycling system of the present invention; and

FIG. 2 illustrates an embodiment of an activity path of a consumer using the recycling system of the present invention.

### BRIEF DESCRIPTION OF THE INVENTION

The present invention discloses an enhanced system for utilizing the coins that would be provided at the conclusion of a cash transaction with a merchant into an account or facility that can be made available at other merchants for use in transactions without the need to carry such coins in clothe pockets or purses. As used in the present invention, an application may be provided to record the recycling of the loose coins that are typically available after a cash transaction at a merchant outlet. Said application could act as an electronic repository of information wherein credits and withdrawals can be logged. The present invention further provides a means to repurpose and utilize the value of loose coins that are often left in car compartments, coin slots, strewn on tables or even discarded due to inconvenience.

According to the present invention, an application is preferably established to receive via merchants or other suitable sources, leftover value for coins from a cash-based transaction. Such an application may be linked to a bank account, customer loyalty program, electronic readable system, or the like. The application is preferably accessible by the customer or consumer and access to deposit or credit transactions provided to merchants who are registered into the system. As an example, a convenience store chain may register or create a receiving or transfer account on the application and would then be provided with requisite and appropriate access to credit accounts of consumers who prefer to lodge their coin change from cash transactions. It is important to note that the merchants may not have access or capacity to withdraw from any of the created accounts, unless such belonged to the merchant; in which case, the merchant shall be the consumer.

At a convenient opportunity, the consumer may provide further identifiable information according to the present invention for use in making feasible transactions based on the facility or the application. The consumer or customer shall at all times have access to all the deposits or credits in the application and may use it at any instance for another transaction as long as such consumer has deposited enough credits to make subsequent transactions possible. The facility or application according to the present invention shall not provide the consumer with a credit where no funds are available and shall not function as a lending facility for any of the users of the system according to the present invention.

The system of the present invention may include a coin collection opportunity, application or facility wherein a subscribed or registered consumer may deposit the loose coins that said consumer may have left at the many and varied locations as previously disclosed. In such transactions, it is reasonable to expect the deposited amount to exceed the less-than-one paper money unit. According to the present invention, a paper money unit is preferably deemed to include a one-dollar bill, or any usable currency which is the lowest denominated unit available in paper currency. It is also reasonable to imagine a consumer yearning to use this facility or application to save some funds. Such instance or instances may make for transactions which would not only involve the lowest paper currency unit but some or all the change attendant from a cash transaction. As an example, a cash dollar-denominated transaction may have a change of more than a dollar due back to the consumer who then preferably opts to have said balance of that transaction credited to their coin facility or application according to the present invention. Such transaction may require some level of authentication since the coin recycling system of the present invention is not primarily aimed at creating a banking facility as banks are presently utilized.

Further to this invention is disclosed a system for a consumer who, at the instance of a transaction at a subscribed merchant may opt to be provided and utilize a machine readable or electronic account. The creation of such account should preferably occur as each electronic coded card automatically opens a unique facility for such loose coin deposit or credit. Said account may then preferably be used to channel the loose change or coins from the cash transaction to the created account. Once the consumer has a created account, such consumer may be provided a bar-code readable card usable for future transactions instead of being burdened with the weight and inconvenience of collecting coins back from a transaction. It is reasonable to provide an app for a smart phone or tablet that would be cross-readable by the consumer and merchant for such transactions.

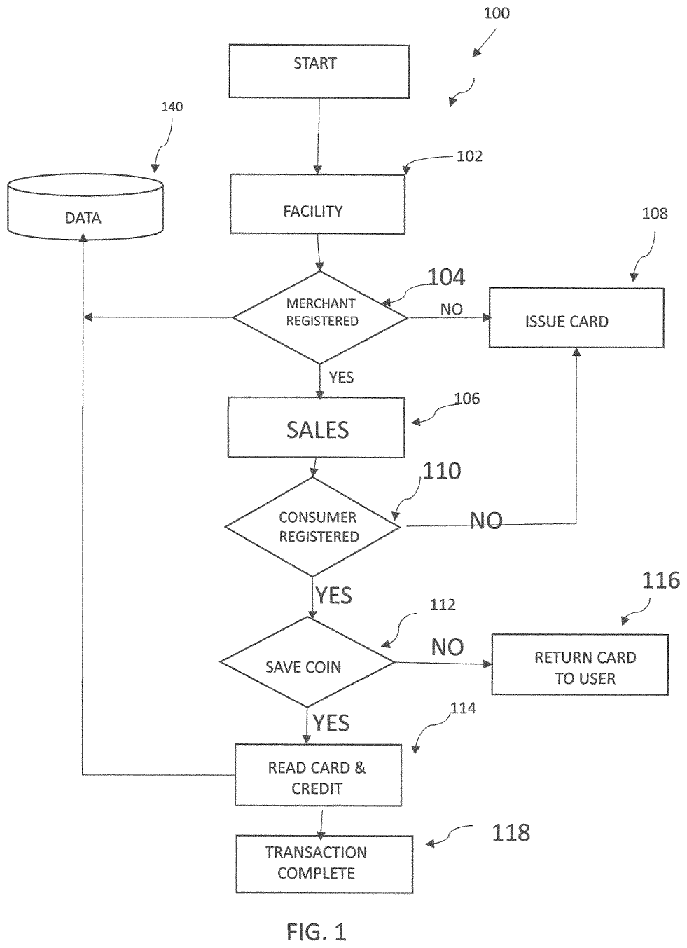

FIG. 1 illustrates a system 100 of the present invention wherein an application 102 is established to centrally process transactions from merchants and users. Such application may be available for use after the requisite software is developed to accept, monitor and perform all needed transactions according to the present invention. A database or a data file 140 may be created to store or process all the information according to the present invention. Such database or storage 140 may, by necessity, be linked to merchants who are part of the network and accessible to the user for confirmation of his or her credits (a balance checking opportunity).

A merchant or consumer participating in the present invention must, by necessity, register using an application to be able to serve the customer or user when and if they desire to use the system of the present invention to recycle their coins change or such loose coins or money that may be used as savings or for such later use. Such registration will provide pertinent information about the merchant or consumer and offer the needed processes to make the transaction successful. The merchant or consumer shall have access to communication opportunities needed to almost instantaneously link and assess the information of the user as needed to make the transaction proceed.

A machine-readable card may be introduced to identify and assign to a user according to the present invention. Such machine-readable card may include bar codes, RFID tags, biometrics, or any suitable means to link the user to the credits or deposit made as they convert their coins according the system of the present invention. It is reasonable to expect the use of an app for phones or tablets to meet the need of a bar-coded or otherwise useful card identification system. A user may have the opportunity to deploy one or more of these linking tools as convenient or preferable with the present invention.

When a user conducts a sale transaction at a merchant, said merchant shall scan or otherwise read or enter the user's card or app to credit the coin change from a transaction. If the user presented does not have a card, app or an account with the system of the present invention, the merchant using an app shall offer the user an opportunity to enroll and immediately credit his or her coins by providing blank or non-activated cards 108 to the user. The loose change or coin balance from the transaction that would be available in coins shall automatically be credited to the user's account if the user or consumer prefers to. At a later or convenient time, the user may access the system of the present invention to provide personally identifiable information to link the card with the user. In instances where a user does not want to participate, a merchant shall always have the opportunity to give the user his or her change in coins.

As an example, a user at a point of sale with a registered merchant 104 decides to credit their coin change or balance from a sale transaction to the recycling system of the present invention. If the user is not already registered with the facility or application of the present invention, the registered merchant may issue such registration card 108 to the user. A registered user may then credit the change available from the transaction to the registered account.

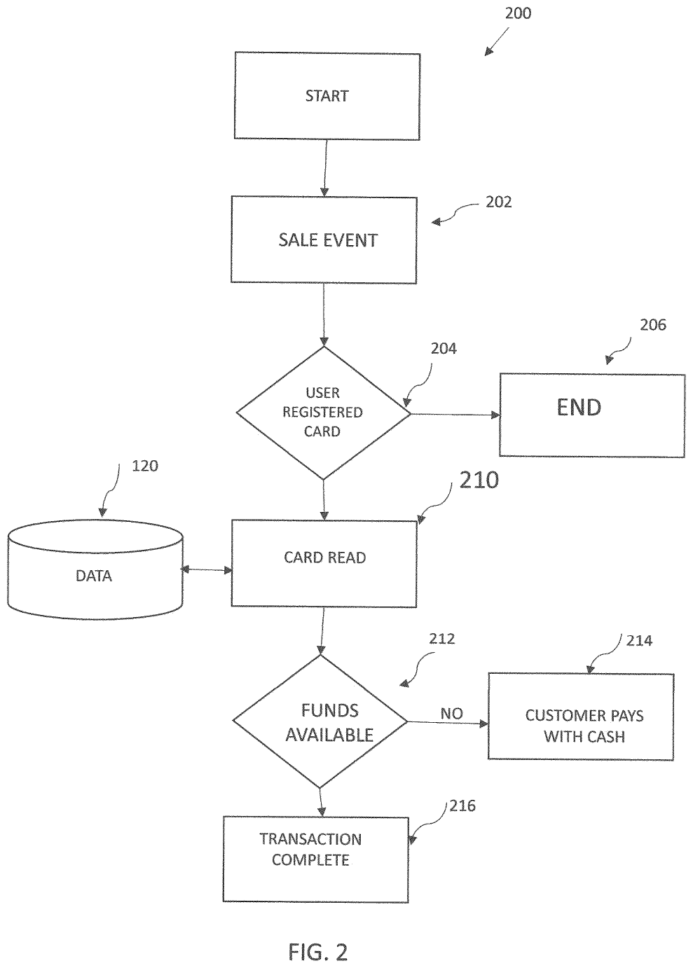

FIG. 2 illustrates a registered user of the present invention accessing the stored value from the facility for use at a point of sale or to determine how much is available to his or her credit with the facility. When a registered user at a merchant conducting a sale 202, and desiring to use the credit in the facility or application, such user shall present his or her card, or an app as appropriate to the merchant. A quick scan or read of the card or such app shall confirm availability of a balance that may be sufficient to cover the transaction. As an example, if a transaction in US was $60.87, a user might provide the merchant with sixty dollars in paper currency and a registered card or app from which the 87 cents may be withdrawn to complete the transaction. Such process avoid to unneeded efforts to search out 87 cents from the bottom of a purse, present a one dollar bill for another 13 cents which might end up in some uncontrolled or irretrievable location. When a user uses the card or app according to the present invention, the credits and debits are recorded and available for review.

Having thus described the preferred embodiments of the present invention, those of skill in the art will readily appreciate that the teachings found herein may be applied to yet other embodiments.

What is claimed is:

1. A method of recycling coins, comprising:
creation of an application to record transactions by merchants and consumers,
registration by a merchant with the application,
registration by a consumer with the application, and
crediting a loose coin balance of a cash transaction to the application or a facility, wherein such credit is available for later use a merchant without physically handling coins.

2. The method of claim 1, wherein the application is an electronic repository for registering merchants.

3. The method of claim 1, wherein the registration includes provision of communication systems for recording transactions between the merchant and application.

4. The method of claim 1, wherein the registration system includes a provision of an electronic readable means.

5. The method of claim 4, wherein the electronic readable means includes but not limited to RFID cards, biometrics, phone and tablet apps.

6. The method of claim 1, wherein a user can register with the application.

7. The method of claim 7, wherein the registration is done at the point of sale or transaction with the merchant.

8. The method of claim 1, wherein the later use by the user includes using the electronic readable means to pay a balance a transaction at a merchant.

9. The method of claim 1, wherein the user registration can be formalized at a later time to include personally identifiable information.

10. The method of claim 1, wherein the user has access to check and update the account balance at any time.

11. The method of claim 1, wherein the user can conduct a transaction at any merchant registered with the facility.

12. A coin recycling system, comprising:
an electronic repository
a merchant account at the repository
a user account at the repository
a means to exchange loose coins from a transaction into a record at the repository for later use at a merchant.

13. The system according to claim 12, wherein no coins are physically handled.

14. The system of claim 12, wherein the merchant account is a formalized process to record and accept transactions.

15. The system of claim 12, wherein the user can initialize an account at a merchant at point of sale.

16. The system of claim 12, wherein a loyalty system is created for frequent users.

17. The system of claim 12, wherein a user can credit coins outside of a point of sale transaction.

18. The system of claim 12, wherein the user has access to the credits in the facility.

19. The system of claim 12, wherein the user is provided an electronic or machine readable card or identification by the merchant.

20. The system of claim 12, wherein the user can use their account at any merchant registered with the repository.
